(19) United States
(12) Patent Application Publication
(10) Pub. No.: US 2017/0225424 A1
(43) Pub. Date: Aug. 10, 2017

(54) Creasing corrugated board

(71) Applicants: Joseph J. Weishew, Oreland, PA (US); Ronald W. Diedeman, Phoenix, MD (US); Joseph A. Porcella, Bel Air, MD (US)

(72) Inventors: Joseph J. Weishew, Oreland, PA (US); Ronald W. Diedeman, Phoenix, MD (US); Joseph A. Porcella, Bel Air, MD (US)

(73) Assignee: Sun Automation, Inc., Sparks, MD (US)

(21) Appl. No.: 14/998,725

(22) Filed: Feb. 8, 2016

(51) Int. Cl. B31F 1/08; B31F 1/36

(52) U.S. Cl. CPC B31F 1/08; B31F 1/36

(57) ABSTRACT

Corrugated boards are creased in three stages: the first being controlled crushing of the board to force air out of the flutes; the second is applying heated moisture or mist to the board to increase pliability; and the third is creasing the board by passing it between endless conveyor belts one of which has an elongated scoring bead projecting from its inner surface.

### FIELD OF INVENTION

The present inventions are methods and apparatus for creasing boards or boxes typically made from material commonly referred to as “corrugated board”.

### BACKGROUND OF INVENTIONS

Typically a Flexo-Folder-Gluer is used to produce corrugated boxes also known in the art as RSC's (Regular Slotted Cartons).

A Flexo-Folder-Gluer performs its basic functions as follows:

Flat corrugated blank sheets (also termed “boards”) are fed one at a time from a stack into the machine by a feeding mechanism.

One side of the sheet can be printed typically using printing plates mounted on to a rotating cylinder.

Slots are cut into the front and rear edges of the corrugated sheets while longitudinal crease lines connecting the slots are impressed into the sheet to produce four side-by-side panels.

A glue tab is cut on one side of the corrugated sheet and glue is applied to a tab.

A folding mechanism folds the two outside panels of the corrugated sheet 180° and creates a folded box (knocked down or flat state) as the glue tab panel meets the opposite side panel.

A counter ejector mechanism accepts the folded boxes and discharges them in stacks.

The dimensional accuracy of a folded box is primarily determined by the above-described creasing process used to produce the creases in the sheet that will define the box panel sizes. A common method used to crease sheets employs multiple sets of upper and lower rotating scoring heads or rolls. Referring to FIG. 1 of the drawings, male scoring bead (A) compresses the corrugated board into the female ring (B). This nip forms a longitudinal crease line (C) in the sheet (FIG. 1a). There is a critical value of nip pressure that must be maintained in order to produce a useful crease line. Too little pressure results in undefined scores, whereas extreme pressure will cut or crack the liner paper of the board (E) and (F). After the creasing process, the two outside panels in the sheet are urged either up or down 180° by some folding method, generally stationary bars (FIG. 1a) or moving belts. Due to the many variables encountered in the manufacture of corrugated board, such as liner and medium paper weights, moisture content and recycled grade of paper, and flutes (G) adjacent to the crease line that may be weaker than the crease line itself, panels might fold about a “false” score line (D). This will produce a folded box whose panels are dimensionally inaccurate and not within specifications. These so called “rolling scores” can occur at any time during a production run and are very difficult to eliminate using this type of scoring method. By nature, folding a corrugated sheet requires the outer liner paper (F) to stretch, the inner paper liner (E) to contract, and the corrugated medium paper (H) to compress.

### SUMMARY OF PRESENT INVENTIONS

In order to better control the dimensional accuracy of folded panels, a novel and improved creasing method and apparatus are provided by the present inventions that will condition and prepare a sheet in a non-destructive manner and produce well-defined creases. The benefits of this proposed creasing method will be to eliminate crease-line cracking of the inner liner due to the creasing process, eliminate cracking of the outer liner due to the folding process, and produce well defined creases in the sheet that will allow accurate folding about the true crease line as shown in (FIG. 1b).

The method of the present invention includes the steps of compressing the boards to a controlled amount to force the air out of the flutes in the area which will include the score line to be formed. A steam shower mist is applied to the board to prevent cracking in the area where the crease will be formed. A crease line is then pressed or “ironed” into the above pre-conditioned areas by an elongated scoring bead for an extended period of time. In one preferred method the boards are fed in the nip between endless bands one of which contains an elongated and scoring endless bead and forms the crease as the board proceeds through the bands.

### DRAWINGS

Other objects and advantages of the present invention will become more apparent from the following description taken in conjunction with the attached drawing in which:

FIG. 1 is a fragmental cross-sectional view of apparatus used for creasing corrugated boards in accordance with the prior art;

FIG. 1a is a fragmental cross-sectional view of a corrugated board that has been folded but not at the intended crease line representing the problem caused by methods and apparatus of the prior art;

FIG. 1b is a view similar to FIG. 1a but showing a properly formed crease produced by the method and apparatus of the present invention;

FIG. 2 is a side elevational view of preferred apparatus for performing the creasing method of the present invention;

FIG. 2a is a cross-sectional view taken along lines A-A of FIG. 2;

FIG. 3 is a schematic top view of the apparatus of FIG. 2;

FIG. 4 is a plan view of a board showing the crease lines in dotted lines; and

FIGS. 5A, B, C and D are side elevational views of another preferred apparatus of the present invention showing both vertical and angular adjustment of platens which engage creasing bands for creasing the boards.

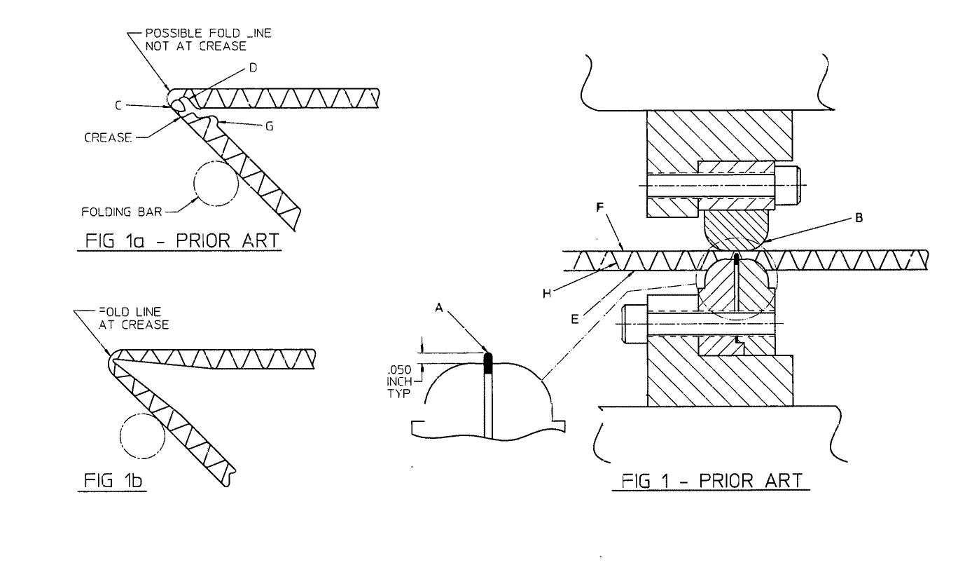

### DETAILED DESCRIPTION OF INVENTION

Referring to the drawings in detail there is shown for illustrative purposes only, preferred methods and apparatus embodying the present inventions.

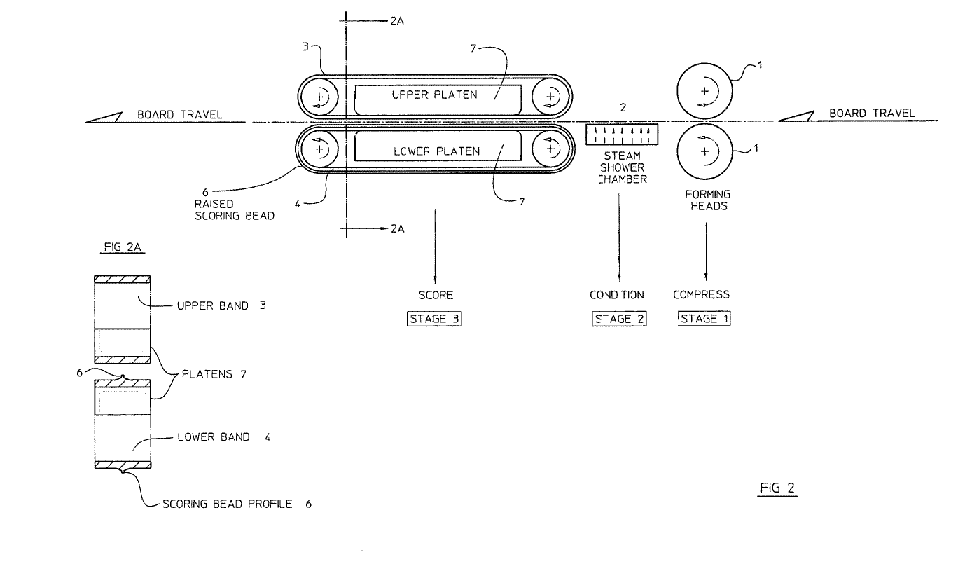

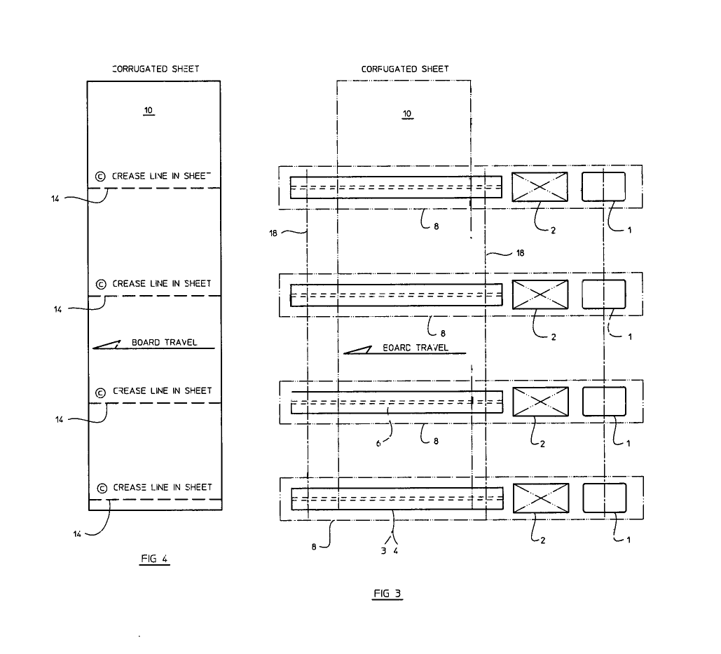

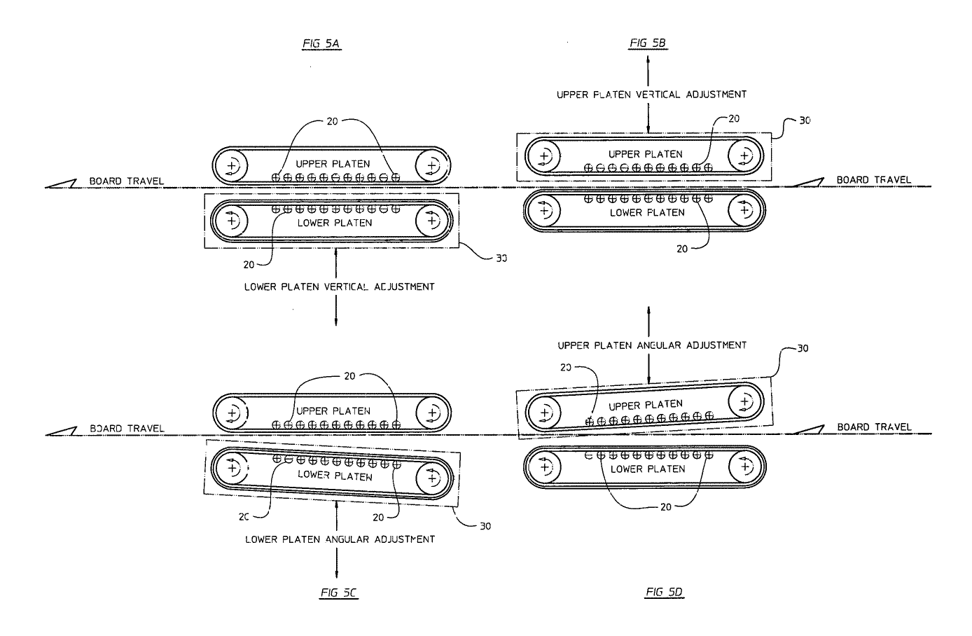

According to the present invention, the creasing method shown in FIG. 2 employs three distinct stages, each providing a specific operation needed to produce a well-defined score line in the corrugated board 10 in FIGS. 3 and 4 where in this particular box to be formed requires four creases or scores shown by dotted lines 14 in FIG. 4. As shown in FIG. 3 four creasing systems are used to produce the required four creases respectively. Each system includes compression or forming beads 1, a steam shower or mist chamber 2 and what will be termed here as a “creasing conveyor” comprised of overlying and underlying endless belts 3 and 4 as shown in FIG. 2.

Referring to FIG. 2, Stage 1 performs a mechanical operation by passing the corrugated board through a nip of rotating forming heads or pinch rolls (1) to compress and impart a controlled crush into the sheet while forcing air out of the flutes in the area which will contain the score line. Rolls 1 further serve to convey the board 10 along the horizontal processing path to the next operating station where it enters a chamber 2 for Stage 2.

Stage 2 supplies moisture and heat, preferably a steam shower mist, in chamber 2 to the side of the board in the area where the crease will be formed. The heat and moisture supplied at this point will aid in conditioning the fibers of the inside liner paper to help make the board more pliable and prevent cracking when the crease is introduced into this surface. It should be noted that crease line cracking will weaken the structure and lead to failure. Additionally, crease line cracking is visible to the customer and reveals itself as a quality issue. The amount of moisture and subsequent time to condition the paperboard is dependent on the thickness of the paperboard and ambient conditions.

After the board emerges from the chamber 2, it is conveyed along a horizontal path to the creasing conveyor at Stage 3 that “irons in” a score profile into the pre-conditioned area of the board by means of upper and lower continuous nip “bands” or belts 3, 4. The latter are of a predetermined length in order to provide extended contact time between the board and a raised scoring bead (6). The “bands” 3, 4 can be made from but not limited to an elastomeric material such as rubber or urethane, or a plastic or metal continuous or segmented in which one band has a projecting scoring bead 6 as a part of its surface as shown in FIG. 2a. Each “band” is driven over a platen 7 such as a flat plate shown in FIGS. 2 and 2a or a series of rollers shown in the embodiment of FIGS. 5a-5d. The upper and lower platens form a compressive nip on the sheet and as shown in FIG. 5a and b are adjustable in a vertical direction to accommodate different board calipers, and are also adjustable angularly by pivoting about a horizontal axis extending transversely to the conveyor path of the lower rollers 5c or upper rollers 5d, or both sets of rollers to provide progressive contact creating a gradual crease. This adjustability allows for extended, gradual creasing to accommodate varying flute profiles; varying base weight (thickness) liners and medium paper; varying quality liners and medium; varying creasing profiles; environmental conditions, e.g. temperature, relative humidity, etc. In the embodiment of FIGS. 5a-d, the platen rollers 20 are rotatably mounted in any suitable frame 30 which is mounted for vertical movement and for pivotal movement about a horizontal axis extending transverse to the conveyor path to provide the above indicated adjustability of the platens.

As shown in FIG. 3, each of the four creasing systems including apparatus of the three stages are preferably mounted on frames 8 which may also be mounted to a common yoke bar 18 to be able to travel across the board to adjust for different panel sizes of the boards.

Although preferred embodiments of the present inventions have been shown and described above, variations of these embodiments will become apparent to those of ordinary skill in the art but without departing from the scope of the present inventions defined in the attached claims.

We claim:

1. Method for creasing corrugated board comprising in combination the steps of:
Compressing the board to force air out of flutes in the board,
applying heat and moisture to the board at the area to be creased to render said area more pliable and less susceptible to cracking during creasing, and
pressing and progressively moving an elongated creasing bead on said area along a line to form a crease along said line.

2. The method defined in claim 1 further including the step of moving the board between overlying and underlying moving endless belts wherein one of said belts has a creasing bead projecting from its surface and forming the crease as the board progresses through the belts.

3. The method defined in claim 1 wherein prior to being creased the board is moved through pinch rolls to perform the compressing system.

4. The method defined in claim 1 wherein prior to being creased the board is moved through a chamber where a steam shower mist is applied to the board to provide the heat and moisture recited above.

5. The method defined in claim 2 wherein prior to being creased the board is moved through pinch rolls to perform the compressing step and wherein prior to being creased the board is moved through a chamber where the step of applying heat and moisture to the board is performed.

6. A system for creasing corrugated boards comprising in combination:
a pair of pinch rolls for receiving the board to compress the same to force air out of flutes in the board,
means for applying moisture to the board to render the area to be creased more pliable and less susceptible to cracking during creasing, and
overlying and underlying endless belts for receiving and moving boards along a path, one of said belts having an elongated bead projecting from its surface to form a crease in the board as the board moves through said belts and after the board has been compressed and moistened as recited above.

7. The system defined in claim 6 wherein said belts each have a platen engaged on one of its sides to produce predetermined pressure on said board for creasing the board.

8. The system defined in claim 7 wherein at least one of said belts has a platen engaged on one of its sides to apply pressure on said board for creasing said board, said platen being adjustable towards and away from said path of movement of said belts.

9. The system defined in claim 8 wherein said platen is adjustable in vertical direction.

10. The system defined in claim 8 wherein said platen is pivotable about a horizontal axis transverse to said path of movement of said belts.

11. Apparatus for creasing corrugated boards including overlying and underlying conveyor belts for receiving and moving a board along a path, one of said belts having a bead projecting from its outer surface for engaging and creasing a board as it moves through the belts, and means for applying pressure on said belts and in turn said board as the board is moved through and creased by said belts.

12. Apparatus defined in claim 11 wherein said means for applying pressure on said belts are platens engaged on the inner surfaces of the belt along an area of the board being creased.

13. Apparatus defined in claim 11 wherein means for applying pressure on at least one of said belts includes a platen that is adjustable towards or away from said one belt.

14. Apparatus defined in claim 10 wherein said means for applying pressure on at least one of said belts includes a platen which is both vertically and angularly adjustable towards or away from said one belt.
